(19) United States
(12) Patent Application Publication
(10) Pub. No.: US 2006/0021483 A1
(43) Pub. Date: Feb. 2, 2006

(54) Tool for cutting armored cables

(76) Inventor: Lucien C. Ducret, Stamford, CT (US)

Correspondence Address: YURI KATESHOV, 174 FERNDALE RD, SCARSDALE, NY, 10583, US

(21) Appl. No.: 10/909,942

(22) Filed: Aug. 2, 2004

(51) Int. Cl. B26D 5/00; B27B 17/00

(52) U.S. Cl. 83/13; 83/745

(57) ABSTRACT

A tool for cutting an armored casing includes two upper and lower housing members biased away from one another by a resilient element, a handle pivotally coupled to the lower housing member, and an additional resilient element biasing the handle away from the lower and connected to a clamping stud. The additional resilient element is configured to yield to an initial compression force applied to the housing members and handle and sufficient to displace the clamping stud toward and engage the armored casing in a clamping position. By increasing the external force, the housing members move to a cutting position, in which a circular saw is operative to cut the clamped armored casing.

### BACKGROUND OF THE INVENTION

1. Field of the Invention

This invention relates to tools for cutting armors and shields of cables. In particular, the invention relates to hand-held tools for cutting armors of cables.

2. Discussion of the Prior Art

A task of removing armored casings off armored and shielded cables is too well familiar to professional and amateurs. Used in a variety of industries, cutting armored cables require strong efforts usually associated with unpleasant cuts, nicked fingers and traumatized knees.

Hand-held tools for removing armored casings have addressed many of the known inconveniences over the years. Widely popular hand-held cable cutters manufactured by SEATEK CO. INC, the assignee of the present invention, have been disclosed in U.S. Pat. Nos. 3,851,387, 4,359,819, and 4,769,909, the disclosures of which are incorporated herein by reference. The tools disclosed in these patents have minimized the need for using hacksaws in the cutting of shielded conduits and allowed the user to cut the armor without the blade touching the conduit or cable materials below the armor. Field proven quality cutters disclosed in these patents accept BX cable from 14/2 to 8/4 and ⅜″ Flex as well as AC, MC & HCF cables.

In use, these tools allow the user to temporarily clamp the cable in the proper position and have its armored casing cut longitudinally by a circular saw. This operation takes only a few seconds. It is absolutely safe and does not damage the wires inside due to the unique built-in depth of cut stop.

Typically, the known cutters have a limited clamping range. To reliably engage cables having various outer diameters, the user operates a thump screw adjusting a distance between a clamping lever and the free end of clamping stud coupled to the thump screw.

Often the user operates a cutter under time and space constrains. Manual operation of the thump screw may add to the inconvenience experienced by the user. For example, balancing on the top of a ladder or crouched on a narrow support, the user may jeopardize his/her safety. Furthermore, a relatively simple and thus time-efficient operation of removing an armed casing may turn into a time-consuming, onerous experience.

As a rule, after a cable has been clamped, the user would generate an additional compressing force applied to clamping levers in order to displace a saw into the armored casing. Sometimes this force may be sufficient to crush the armor by the clamping stud. This, in turn, may damage cable material shielded by the armor.

A need thus exists for a cable clamping system associated with armor cutting tools and operative to automatically adjust a clamping range for differently sized cables.

A further need exists for armor cutting tools operative to minimize direct forces acting upon a clamped cable during cutting armored casings.

Still another need exists for improved, time saving, labor efficient and safe cutting techniques used for removing armored casings off differently dimensioned cables.

### SUMMARY OF THE INVENTION

The present invention is directed to methods and tools that satisfy these needs. The invention includes a method of cutting an armored casing of variously dimensioned cable without a need to manually readjust a clamping mechanism configured to reliably hold the cable for further cutting operations. A cable is initially received in a cable-receiving channel of a lower housing member. Applying an initial external force to a handle causes a clamping stud to extend at the necessary distance sufficient to clamp the cable between the clamp and the wall of the cable channel.

Subsequently, the user applies an additional force greater than the initial force to displace upper member of the housing towards the lower member. As a consequence, a circular saw housed in the upper member of the housing penetrates the armored casing and produces a longitudinal cut.

Thus, the inventive cutting tool utilizes a system of levers amplifying the clamping motion of the clamping stud while retaining the necessary force to bias the clamped cable against a supporting surface during performing a cutting operation. The inventive tool eliminates a need for manually adjusting a distance between clamping surfaces.

The inventive tool includes two housing members resiliently biased away from one another and hingedly attached to one another. A handle is pivotally mounted on a distal end of one of the housing members and is resiliently biased away therefrom. The handle is operative to pivot in response to an initial force so that its free end, while moving towards the one housing member, causes the clamping stud to follow its displacement until a free end of the stud presses against the cable.

A resilient element is mounted between the handle and the housing member to bias these components away from one another. Having a module of resilience lower than a module of resilience of a spring element biasing the housing members, the resilient element coupled to the clamping is displaced in response to the initial force applied to the handle. Once the stud presses against the cable, a second force greater than the initial force is again applied to the handle and housing members so that the members move to a cutting position, in which the circular saw is enabled to cut the armored casing.

These and other features and aspects of the present invention will be better understood with reference to the following description, figures, and appended claims.

### BRIEF DESCRIPTION OF THE DRAWINGS

FIG. 1 represents a side elevation of the inventive tool shown in an initial loading position, in which a small length of cable is received in a cable channel, parts being broken away;

FIG. 2 represents a side elevation of the inventive tool shown in a clamping position, in which a small length of cable is clamped, the crank being omitted;

FIG. 3 represents a side elevation of a portion of a housing and a lever system in accordance with another embodiment of the invention;

FIG. 4 represents a detailed view of one of the embodiments of the lever system;

FIG. 5 represents an end portion of a retainer of the lever system shown in FIG. 4; and

FIG. 6 represents a detailed view of a formation configured to actuate one of the lever system components in response to applying an external force to the other component of the lever system.

### DETAILED DESCRIPTION OF THE PREFERRED EMBODIMENT

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, proximal, and distant may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices. The terms “armor” and “armored casing” are used interchangeably.

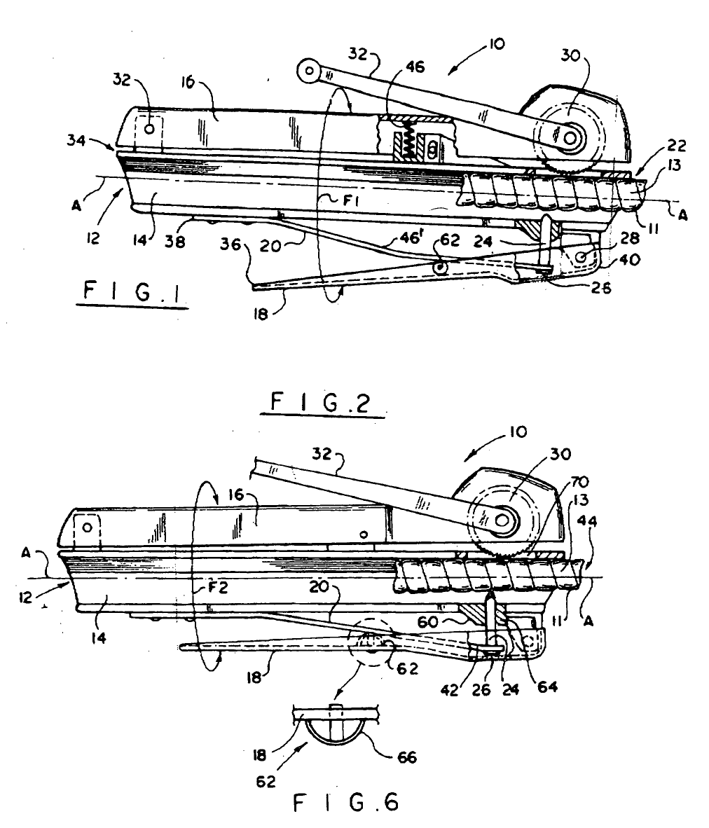

Referring to FIGS. 1 and 2, the inventive tool 10 is configured with a channel 22, which is shaped and dimensioned to selectively receive differently sized elongated armored cables. The tool 10 is operative to initially clamp an armored cable 11 and subsequently cut an armored casing 13. In operation, after placing the armored cable in the channel 22, the user holds a housing 12 and lever handle 18 applying to these components an initial compressive force sufficient to displace the lever handle from a rest position of FIG. 1 to a clamping position, illustrated in FIG. 2. As the lever handle 18 moves towards the clamping position, a clamping stud 24 displaces toward and urges against the armor 13, which is thus firmly held between the clamp stud 24 and the supporting surface of the channel 22.

After reliably securing the armored cable 11 in the channel 22 in the clamping position, the user applies an additional compressive force displacing a housing member 16 relative to the lever handle 18 and causing a circular saw 30 to advance towards and penetrate the armored casing 13. Actuation of a saw handle 32 results in an axial cut of the armor 13.

Turning now to details of the inventive tool 10, the lever handle 18 has a distant end 40 pivotally attached to a distal end 44 (FIG. 2) of the housing 12. As a result, the lever handle is operative to pivot about a pin 28 (FIG. 1) between the rest and clamping positions. In the rest position, as shown in FIG. 1, the lever handle 18 extends angularly outwards relative to a longitudinal axis A-A and has its proximal end 36 spaced from the housing 12. Mounted to freely pivot about the pin 28, the lever handle 18 pivots to the clamping position displacing thus the proximal end 36 towards the housing 12.

The lever handle is resiliently loaded by a lever 20 configured as a leaf spring to resist the lever handle's displacement to the clamping position. Coupled to the housing 12 by its proximal end 38 (FIG. 1), the lever 20 exerts a springing force acting against the lever handle 18 and supporting the handle 18 in the rest position. Applying an initial compression force F₁, sufficient to overcome the springing force of the lever 20, displaces the lever handle 18 to the clamping position, as illustrated in FIG. 2. Due to the configuration of the housing 12 and lever 20, preferably, the lever handle 18 extends substantially parallel to the longitudinal axis A-A in the clamping position. However, various configurations can be easily implemented so as to position the lever handle 18 at an angle relative to the longitudinal axis in the clamping position.

The lever 20 has a longitudinal body extending angularly outwards from the housing 12 and terminating in the vicinity of the distal end 40 of the lever handle 18. A distal end 42 (FIG. 2) of the lever 20 is substantially aligned with a rotation axis of the circular saw 30 in a plane extending transversely the longitudinal axis A-A. Preferably, but not necessarily, the body of the lever 20 has at least one bent 46′ (FIG. 1) configured so that the distal end 42 of the lever 20 is juxtaposed with and spaced from the distal end of the lever handle 18. Made from metal or engineering plastics, the lever 20 is sufficiently resilient to support the lever handle 18 in the rest position.

To clamp the armored cable 11, the clamping stud 24 is displaced towards the cable-receiving channel 22. Depending on an outer diameter of the cable 11, the clamping stud 24 projects into the channel 22 until its free end presses the cable 11 against the supporting surface of the channel 22. Once the cable 11 is reliably locked, the clamping operation is completed, and the armor 13 is ready to be cut.

Displacement of the clamping stud 24 is a result of application of the initial compression force F₁ (FIG. 1) causing the lever handle 18 to pivot to the clamping position. As the proximal end 36 of the lever handle 18 continues its displacement towards the housing 12, the handle pushes the distal end 42 of the lever 20 and the stud 24 inwards. The clamping stud 24 and the distal end 42 of the lever 20 are displaceably fixed. Accordingly, displacement of the lever 20 invariably forces the clamping stud 24 to move as well.

In accordance with one embodiment, the distal end 42 of the lever 20 has an opening traversed by a head 26 of the clamping stud 24, as shown in FIGS. 1, 2. To facilitate coupling between clamping stud 24 and lever 20, its body may have a narrow or recessed neck located immediately next to the head 26. Thus, as the neck of the stud 24 is received within the opening of the lever 20, the head 26 terminates between the lever 20 and lever handle 18.

Alternatively, as shown in FIGS. 4 and 5, the tool 10 includes a retainer 50 configured to engage the neck of the head 26 of the clamping stud 24. Coupled to a distal portion of an inner side 54 (FIG. 4) of the lever 20, the retainer 50 is made from resilient material and configured to press the head 26 of the clamping stud 24 against the side 54 of the lever. Note that the distal end 42 of the lever 20 may be curved with a radius of curvature “R” slightly smaller than a radius of curvature “r” of the retainer 50. Such a configuration allows the edge of the retainer 50 to close a gap between the distal ends of the lever 20 and the retainer 50 preventing thus inadvertent disengagement of the stud's head 26 from a recess 52 (FIG. 5). Furthermore, increasing the initial compression force, which is necessary for further cutting of the armor 13, as explained below, causes a distal edge 72 of the retainer 50 to press against and bends the lever's distal end 42 outwards. As a result, the clamping stud 24 will not experience the full magnitude of the additional compression force F₂ necessary for the cutting operation.

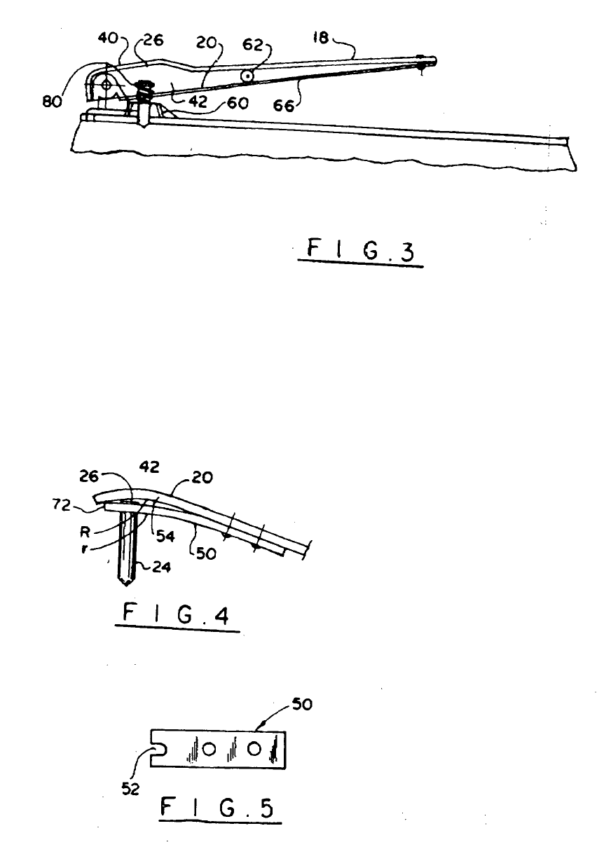

A further factor contributing to limited penetration of the stud 24 into the armored casing 13 (FIGS. 1, 2) includes a formation 62 (FIGS. 1-3) spaced from opposite proximal and distal ends of the lever 20 and lever handle 18 and extending between these components. During displacement of the lever handle 18, a region 66 (FIG. 3) of the lever 20 opposing the formation 62 will be experiencing a maximum force in the cutting position upon applying the additional force F₂. As a result, a force applied to the clamping stud 24 in the cutting position is somewhat reduced depending on a distance between the formation 62 and the distal end 42 of the lever 20. In addition, because of the inherent flexibility of the lever 20, a reactive force, which is generated by the clamped cable 11 and directed opposite to the force F₂, will bend the distal end 42 (FIG. 2) of the lever 20 outwards from the cable. Such a structure minimizes the risk of penetration of the stud 24 through the armored casing 13, which otherwise, can damage material within the cable.

The formation 62 may have various forms and dimensions. For example, FIG. 1 illustrates a roller bridging opposite sides of a U-shaped lever handle 18. FIGS. 2 and 6, in turn, illustrate a half-moon shoe structure having its apex pressed against the lever 20. Although the formation 66, as seen in FIG. 2, is detachably mounted on the lever handle 18, it can be readily mounted to the lever 20, provided that the apex presses against the inner surface of the lever handle.

In accordance with a further aspect of the invention, instead of the longitudinal lever 20, a compression spring 80 (FIG. 3) may be braced between the underside of the stud's head 26 and the stop 60 or directly the housing 12. The spring 80 is so selected that its module of resilience is lower than the module of a resilient element 46 (FIGS. 1, 2), which biases multiple housing members away from one another. The spring 80, similarly to the lever 20, is configured to generate a force directed in a direction opposite to the initial force transmitted from the handle 18 via the formation 62. In this embodiment, the lever 20 has its proximal end 38 fixed to the proximal end of the lever handle 18

Turning now the housing 12, it extends along the longitudinal axis A-A (FIG. 2) between a proximal end 34 (FIG. 1) and the distal end 44 (FIG. 2) and includes two housing members 14 and 16. Respective proximal ends of the housing members 14, 16 are pivotally connected to one anther by a hinge 32. Displacement of these housing members causes the circular saw 30 to advance through a slot 70 (FIG. 2), which is aligned with the clamping stud 24, towards the cutting plane.

Housed in one of the members 14, 16 is a resilient element 46 (FIG. 1) having resiliency module higher than the lever 20. Accordingly, the initial force F₁ applied to the tool 10 for displacing its components to the clamping position of FIG. 2 is insufficient to overcome the spring force of the element 46. Only upon applying the additional compressive force F₂, which exceeds the spring force of the element 46 (FIG. 1), the housing members 14, 16 are forced to pivot towards one another to the cutting position. The resilient element 46 includes, but of course, not limited to, a compressive spring. Preferably, the housing members 14, 16 diverge from the proximal end 34 of the housing 12 from one another. Responding to the additional force F₂, the housing members are displaced towards and extend substantially parallel to one another and to the lever handle 18 in the cutting position of the tool.

Thus, the inventive tool 10 allows the user using one hand to automatically adjust a clamping position for various cable sizes. A further advantage of the inventive tool is the fact that the thin, flexible lever 20 can flex in the clamping position thus preventing crushing the armor by the clamping stud.

This document describes the inventive sound transfer methods and devices implementing these methods for illustration purposes only. Neither the specific embodiments of the invention as a whole, nor those of its features limit the general principles underlying the invention. In particular, the invention is not limited to a cable-cutting tool, but includes various clamping devices operating in accordance with the inventive principle. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is served by the claims and their equivalents.

1. A tool for clamping and cutting an armored casing of a cable, comprising:
a housing extending along a longitudinal axis and configured to receive the cable;
an elongated lever handle having a distal end coupled to housing and a proximal end, the elongated lever being pivotal about the distal end between a rest position, in which the proximal end is spaced from the housing, and a clamping position, in which the proximal end is displaced toward the housing in response to an initial external force applied to the elongated lever;
an elongated lever extending between the housing and elongated lever handle and configured to resiliently support the elongated lever handle in the rest position thereof; and
a clamping stud coupled to the elongated lever and extending transversely to the longitudinal axis, the clamping stud engaging the armored casing as the elongated lever yields to the initial external force displacing the elongated lever handle to the clamping position.

2. The tool of claim 1, wherein the elongated lever extends angularly relative to the longitudinal axis and has a proximal end thereof coupled to the housing and a distal end operatively connected to the distal end of the elongated lever and spaced from the housing in the rest position of the elongated lever handle.

3. The tool of claim 2, wherein the elongated lever is formed with a bent portion extending between the proximal and distal ends thereof and configured so that the distal end of he elongated lever is spaced from the housing in the rest position of elongated lever handle.

4. The tool of claim 3, wherein the elongated lever is made from flexible material and exerts a spring force directed against and sufficient to support the elongated lever handle in the rest position thereof.

5. The tool of claim 4, wherein the flexible material includes polymeric material or metal.

6. The tool of claim 2, wherein the clamping stud traverses the distal end of the elongated lever and has a head terminating between the distal ends of the elongated lever and lever handle and fixed to the elongated lever.

7. The tool of claim 2, further comprising an elongated flexible retainer coupled to the elongated lever by a respective proximal end, the elongated flexible retainer having a distal end provided with a recess, the clamping stud traversing the recess and terminating between the elongated lever and flexible retainer.

8. The tool of claim 7, wherein the elongated flexible retainer is operatively connected to a head of the clamping stud and configured to resiliently urge the head of the clamping stud against the distal end of the elongated lever.

9. The tool of claim 1, wherein the housing includes a first and second member each having a respective proximal and free distal end, the proximal ends of the first and second members being pivotally coupled to one another so that the first and second members diverge from one another in the clamping position of the elongated lever handle and move towards one another to extend substantially parallel to the longitudinal axis in response to a second external force co-directed with but grater than the initial external force.

10. The tool of claim 9, wherein the respective distal end of the first member has a longitudinal slot opening into a longitudinal channel provided in the housing for receiving the cable, the slot being aligned with the clamping stud.

11. The tool of claim 10, wherein the second member houses a circular saw extending through the elongated slot to cut an armored casing of the armored cable upon applying the second external force to the first and second members of the housing.

12. The tool of claim 9, further comprising a resilient member extending transversely to the longitudinal axis between the first and second members and configured to generate a spring force biasing the first and second members apart and yielding to a second external force greater than the initial external force and sufficient to move the first and second members to a cutting position, in which the first and second members extend substantially parallel to one another.

13. The tool of claim 11, further comprising a saw actuator mounted to the second member and operative to actuate the circular saw.

14. The tool of claim 1, further comprising a formation located between the elongated lever and lever handle and spaced axially inwards from the proximal and distal ends of the elongated lever handle, the formation being configured to press against the elongated lever in the clamping position, wherein a distal end of the elongated lever is bent away from the cable in the clamping position of the elongated lever handle to prevent uncontrollable penetration of the clamping stud into the armored cable.

15. The tool of claim 14, wherein the formation includes a roller mounted to the lever handle.

16. The tool of claim 14, wherein the formation has a half-moon shoe shape provided with an apex, which lies on the elongated lever or on the elongated lever handle.

17. A tool for clamping an object, comprising:
a housing extending along a longitudinal axis and configured to receive the object;
an elongated lever handle having a distal and proximal end, the distal end being pivotally coupled to the housing so that the proximal end moves towards and away from the housing in response to an initial external force applied to the lever handle and removed therefrom, respectively;
an elongated flexible lever extending between the housing and lever handle and having a respective proximal end fixed to the housing or the distal end of the elongated lever handle and a respective free distal end spaced from the housing, the respective distal end of the flexible lever having a clamping stud extending transversely to the longitudinal axis towards the housing; and
a formation extending between the lever handle lever and flexible lever and spaced axially inwards from the distal end thereof and configured to displace the distal end of the flexible lever in response to the initial external force to a clamping position, in which the clamping stud engages the object.

18. The tool of claim 17, wherein the housing includes a first and second member each having a respective proximal and free distal end, the proximal ends of the first and second members being pivotally coupled to one another in response to a second external force co-directed with, but grater than the initial external force.

19. The tool of claim 18, further comprising a resilient member extending transversely to the longitudinal axis between the first and second members and configured to generate a spring force biasing the first and second members apart and yielding to the second external force sufficient to move the first and second members to a cutting position, in which a circular saw housed in the first member extends in a cutting plane to produce an axial cut in the armored casing of the cable.

20. The tool of claim 17, wherein the formation is detachably coupled to one of the elongated flexible lever and lever handle and includes a roller or half-moon shaped shoe.

21. A tool for clamping an object, comprising:
a housing extending along a longitudinal axis and configured to receive the object;
an elongated handle having a body extending between a distal and proximal end, the distal end being pivotally coupled to the housing so that the proximal end moves towards and away from the housing in response to an external force applied to and removed from the handle, respectively; and
a clamping stud extending from an inner side of the body of the elongated handle perpendicular to the longitudinal axis towards the housing and actuated by the elongated handle to move towards and clamp the object in response to the external force.

22. The tool of claim 21, further comprising a compression spring braced against a head of the clamping stud and the housing and configured to bias the clamping stud away from the housing.

23. The tool of claim 21, further comprising a leaf spring extending transversely to the longitudinal axis between the housing and handle, one of opposite ends of the leaf spring being spaced axially from the clamping stud and coupled to the housing, the other one of the opposite ends being displaceably fixed to the clamping stud.

24. The tool of claim 21, further comprising a leaf spring extending transversely to the longitudinal axis between the housing and handle, one of opposite ends of the leaf spring being spaced axially from the clamping stud and coupled to the distal end of the elongated handle, the other one of the opposite ends being displaceably fixed to the clamping stud.

25. The tool of claim 24, further comprising a formation extending between the spring leaf and handle and spaced axially inwards from the opposite ends of the spring leaf, the formation being coupled to the handle and configured to displace the spring leaf in response to the external force.

26. A method for operating a tool for clamping and cutting an object, the tool comprising a first and second housing members resiliently biased away from one another, a handle pivotally mounted on the second housing member and resiliently biased away therefrom, and a clamping stud coupled to the handle and displaceable therewith towards an object-receiving channel provided within the second housing, the method comprising the steps of:
applying an initial external force to the handle, thereby pivoting the handle so that the clamping stud displaces towards and clamps the object; and
thereafter applying a second external force greater than the initial external force, thereby displacing the first and second members towards one another, wherein a cutting element housed in the first housing member extends therefrom to a cutting plane to produce a longitudinal cut.
